(19) United States
(12) Patent Application Publication
(10) Pub. No.: US 2026/0329423 A1
(43) Pub. Date: Oct. 22, 2026

(54) IMAGE PROCESSING METHOD, ELECTRONIC DEVICE, AND NON-TRANSITORY COMPUTER-READABLE STORAGE MEDIUM

(71) Applicants: BYTEDANCE TECHNOLOGY LTD., Grand Cayman (KY); BEIJING ZITIAO NETWORK TECHNOLOGY CO., LTD., Beijing (CN)

(72) Inventors: Jiawen XIAO, Beijing (CN); Ye YUAN, Los Angeles, CA (US); Lu XU, Los Angeles, CA (US); Guanshu CHEN, Beijing (CN); Tiancheng DENG, Beijing (CN); Anling MA, Beijing (CN); Wenxuan ZHENG, Beijing (CN); Xueqiong QU, Los Angeles, CA (US)

(21) Appl. No.: 19/651,571

(22) Filed: Apr. 17, 2026

(30) Foreign Application Priority Data
Apr. 17, 2025 (CN) 202510486517.4

(51) Int. Cl. G06F 3/04845

(52) U.S. Cl. CPC G06F 3/04845

(57) ABSTRACT

An image processing method, an electronic device, a non-transitory computer-readable storage medium are provided. The method includes: acquiring a first image and first information of a first template used for the first image, the first information including content information and layout information of the first template; processing at least one of the content information in the first information and the layout information in the first information based on the first image to obtain second information; and generating a second template based on the second information, and processing the first image based on the second template to obtain a second image.

### CROSS-REFERENCE TO RELATED APPLICATIONS

This application claims the priority to and benefits of the Chinese Patent Application, No. 202510486517.4, which was filed on Apr. 17, 2025. The aforementioned patent application is incorporated herein by reference in its entirety.

### TECHNICAL FIELD

Embodiments of the present disclosure relate to the field of multimedia technologies and, in particular, to an image processing method and apparatus, an electronic device, a storage medium and a program product.

### BACKGROUND

In the field of multimedia editing, a template may be designed by combining images and texts, and users may quickly edit the images based on the template.

At present, after the traditional template is designed, the content and layout in the template are fixed. For example, the template may include stickers and texts, and when a user edits multiple images based on the template, the positions of the stickers and texts in each obtained image are the same. However, the inventor(s) found that the traditional template has a problem of not matching with the images.

### SUMMARY

Embodiments of the present disclosure provide an image processing method and apparatus, an electronic device, a storage medium and a program product to solve the technical problems in the prior art.

In a first aspect, an embodiment of the present disclosure provides an image processing method which includes:
acquiring a first image and first information of a first template used for the first image, the first information including content information of the first template and layout information of the first template;
processing at least one of the content information in the first information and the layout information in the first information based on the first image to obtain second information; and
generating a second template based on the second information, and processing the first image based on the second template to obtain a second image.

In a second aspect, an embodiment of the present disclosure provides an image processing apparatus which includes an acquisition module, a processing module and a generation module;
the acquisition module is configured to acquire a first image and first information of a first template used for the first image, and the first information includes content information and layout information of the first template;
the processing module is configured to process at least one of the content information in the first information and the layout information in the first information based on the first image to obtain second information;
the generation module is configured to generate a second template based on the second information; and
the processing module is further configured to process the first image based on the second template to obtain a second image.

In a third aspect, an embodiment of the present disclosure provides an electric device which includes a processor and a memory;

the memory stores computer-executable instructions;

the processor executes the computer-executable instructions stored in the memory to cause the processor to execute the image processing method according to the first aspect and various possible implementations of the first aspect.

In a fourth aspect, an embodiment of the present disclosure provides a computer-readable storage medium, on which computer-executable instructions are stored, and when the computer-executable instructions are executed by a processor, the image processing method according to the first aspect and various possible implementations of the first aspect is implemented.

In a fifth aspect, an embodiment of the present disclosure provides a computer program product, including a computer program, and when the computer program is executed by a processor, the image processing method according to the first aspect and various possible implementations of the first aspect is implemented.

Embodiments of the present disclosure provide an image processing method and apparatus, an electronic device, a storage medium and a program product. The electronic device may acquire a first image and first information of a first template used for the first image, the first information includes content information and layout information of the first template. The electronic device may process at least one of the content information in the first information and the layout information in the first information based on the first image to obtain second information, and the electronic device may generate a second template based on the second information and process the first image based on the second template to obtain a second image. In the above method, the electronic device can adjust the content and layout of the first template based on the first image, so that the accuracy of the generated second template can be improved, and the degree of matching between the second template and the first image can be improved. Moreover, a user does not need to edit the second image obtained based on the second template multiple times, thereby reducing the complexity of image editing and improving the efficiency of image editing.

### BRIEF DESCRIPTION OF DRAWINGS

In order to more clearly explain the technical solutions in the embodiments of the present disclosure or in the prior art, the following will briefly introduce the drawings that need to be used in the description of the embodiments or the prior art. Obviously, the drawings in the following description are some embodiments of the present disclosure. For those of ordinary skill in the art, other drawings may be obtained based on these drawings without creative efforts.

FIG. 1 is a schematic diagram of an application scenario provided by an embodiment of the present disclosure;

FIG. 2 is a schematic flowchart of an image processing method provided by an embodiment of the present disclosure;

FIG. 3 is a schematic diagram of a process of acquiring a first image and first information by an electronic device provided by an embodiment of the present disclosure;

FIG. 4 is a schematic diagram of a method for processing content information provided by an embodiment of the present disclosure;

FIG. 5 is a schematic diagram of a process of generating a second text provided by an embodiment of the present disclosure;

FIG. 6 is a schematic diagram of a process of determining a second design element provided by an embodiment of the present disclosure;

FIG. 7 is a schematic diagram of processing content information provided by an embodiment of the present disclosure;

FIG. 8 is a schematic diagram of a method for processing layout information provided by an embodiment of the present disclosure;

FIG. 9 is a schematic diagram of a process of determining a third design element provided by an embodiment of the present disclosure;

FIG. 10 is a schematic diagram of adjusting a position of the third design element provided by an embodiment of the present disclosure;

FIG. 11 is another schematic diagram of adjusting a position of the third design element provided by an embodiment of the present disclosure;

FIG. 12 is a schematic structural diagram of an image processing apparatus provided by an embodiment of the present disclosure; and

FIG. 13 is a schematic structural diagram of an electronic device provided by an embodiment of the present disclosure.

### DETAILED DESCRIPTION

Here, exemplary embodiments will be described in detail, examples of which are shown in the drawings. When the following description refers to the drawings, unless otherwise indicated, the same numbers in different drawings represent the same or similar elements. The implementations described in the following exemplary embodiments do not represent all implementations consistent with the present disclosure. On the contrary, they are only examples of apparatus and methods consistent with some aspects of the present disclosure as detailed in the appended claims.

It may be understood that before using the technical solutions disclosed in the embodiments of the present disclosure, users shall be informed of the type, range of use, use scenarios, etc. of personal information involved in the present disclosure and obtain the authorization of the users in an appropriate manner in accordance with relevant laws and regulations.

For example, in response to receiving an active request from a user, prompt information is sent to the user to clearly prompt the user that the requested operation will require access to and use of the user's personal information. In this way, the user may independently choose whether to provide personal information to software or hardware, such as an electronic device, an application, a server or a storage medium, that performs the operations of the technical solutions of the present disclosure based on the prompt information.

As an optional but non-limiting implementation, in response to receiving the active request from the user, the prompt information may be sent to the user in the form of, for example, a pop-up window, in which the prompt information may be presented in text. In addition, the pop-up window may also carry a selection control for the user to select "agree" or "disagree" to provide personal information to the electronic device.

It may be understood that the above process of notifying and obtaining user authorization is only illustrative and does not limit the implementations of the present disclosure, and other methods that meet relevant laws and regulations may also be applied to the implementations of the present disclosure.

In the related art, a template may be designed by combining images and texts, and a user may quickly edit the images based on the template. For example, the user may make a picture-text template based on images and texts, and edit the images based on the picture-text template. At present, after the template is designed, the content and layout in the template are fixed. For example, the template may include stickers and texts, and the user edits image 1 based on the template to obtain image 2, and edits image 3 based on the template to obtain image 4, and the stickers, texts, positions of the stickers and positions of the texts in image 2 are the same as those in image 4. However, in the above method, the content and layout in the template may not match the images selected by the user. For example, the stickers in the template may cover the main content of the image, or the texts in the template may not match the content of the selected image, and the user needs to edit the generated image multiple times to make the stickers and texts match the content of the image, which leads to high complexity of image editing and low efficiency of image editing.

In order to solve the technical problems in the related art, an embodiment of the present disclosure provides an image processing method. An electronic device may acquire a first image and first information of a first template used for the first image, and determine third information based on the first image, and the third information may be for indicating information of the first image. The electronic device may process at least one of content information and layout information that are in the first information based on the third information to obtain second information. The electronic device may generate a second template based on the second information and process the first image based on the second template to obtain a second image. In the above method, since the electronic device can process the content information and the layout information in the first template based on the information of the first image, the accuracy of the second template generated by the electronic device is high, and the degree of matching between the second template and the first image is high. In this way, a user does not need to edit the second image obtained based on the second template multiple times, thereby reducing the complexity of image editing and improving the efficiency of image editing.

Next, an application scenario of the embodiments of the present disclosure will be described with reference to FIG. 1.

FIG. 1 is a schematic diagram of an application scenario provided by an embodiment of the present disclosure. Referring to FIG. 1, FIG. 1 includes a first template and a first image. The first template includes sticker 1 and text 2. If the first image is edited based on the first template, in a generated image, sticker 1 and text 2 will cover the object of the first image, and the content of text 2 is unrelated to the object of the first image. An electronic device (not shown in FIG. 1) may change the position of sticker 1 in the first template based on the content of the first image to prevent sticker 1 from covering the object in the first image; the electronic device may modify text 2 in the first template into text 3 to enable text 3 to be related to the object in the first image, and the electronic device may adjust the position of text 3 to prevent text 3 from covering the object in the first image. In this way, sticker 1 and text 3 in the second image cannot cover the objects, thereby improving the display effect of the second image, and reducing the number of times the user edits the second image, thereby improving the efficiency of image processing.

It should be noted that FIG. 1 is only an example of the application scenario of the embodiment of the present disclosure, and is not a limitation on the application scenario of the embodiment of the present disclosure.

The technical solutions of the present disclosure and how the technical solutions of the present disclosure solve the above technical problems will be described in detail below with specific embodiments. The following specific embodiments may be combined with each other, and the same or similar concepts or processes may not be repeated in some embodiments. The embodiments of the present disclosure will be described below with reference to the drawings.

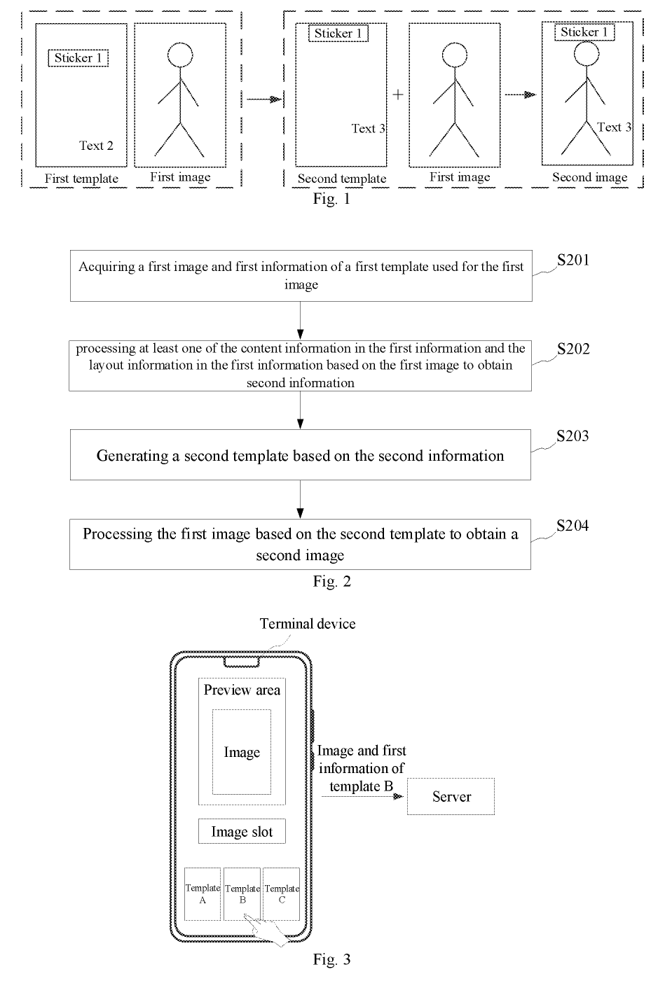

FIG. 2 is a schematic flowchart of an image processing method provided by an embodiment of the present disclosure. Referring to FIG. 2, the method may include the following steps.

S201: acquiring a first image and first information of a first template used for the first image.

An execution body of the embodiment of the present disclosure may be an electronic device or an image processing apparatus disposed in the electronic device. The image processing apparatus may be implemented based on software, and may also be implemented based on a combination of software and hardware, which is not limited in the embodiments of the present disclosure. Optionally, the electronic device may be a device with on-device computing power. For example, the electronic device may be a server, a computer and other devices, which is not limited in the embodiment of the present disclosure.

The first image may be an image to be edited. For example, the first image may be an image selected by a user in a client. For example, the client may display an album based on the user's operation, and the user may select the first image in the album. The client may also display a shooting page based on the user's operation, and the user may shoot the first image based on the shooting page, which is not limited in the embodiments of the present disclosure.

The first template may be a template used for the first image. For example, the first template may be a template selected by the user for the first image in the client. For example, the client may include multiple templates, and the user may select any one of the templates for the first image to obtain the first template.

The first information includes content information of the first template and layout information of the first template. For example, the content information may include text information and design elements in the first template, and the design elements may include elements that constitute the visual appearance and style of the first template, such as filters, stickers, fonts, font colors, text boxes, backgrounds, and so on, and the layout information may include the positions of the design elements in the first template, the structure of the first template, etc., which is not limited in the embodiments of the present disclosure. For example, the first information may include the text, filter, sticker, font, font color, text box in the first template, the positions of the above information in the first template, etc.

In some embodiments, the electronic device may be a server, and therefore, the electronic device may receive the first image and the first information sent by a terminal device. For example, a user may select the first image and the first template used for the first image in the terminal device, and the terminal device may acquire the first information of the first template and send the first image and the first information to the server.

Next, a process of acquiring the first image and the first information by the electronic device will be described with reference to FIG. 3.

FIG. 3 is a schematic diagram of a process of acquiring a first image and first information by an electronic device provided by an embodiment of the present disclosure. Referring to FIG. 3, FIG. 3 includes a terminal device and a server. A page displayed by the terminal device is an editing page, and the editing page includes a preview area, an editing area and a template selection area. The editing area may include an image slot, the preview area may include the image, and the template selection area may include template A, template B and template C. In response to the user clicking on template B, the terminal device may acquire first information of template B and send the image and the first information of template B to the server. In this way, image processing may be implemented on the server, thereby improving the efficiency of image processing.

S202: processing at least one of the content information in the first information and the layout information in the first information based on the first image to obtain second information.

In some embodiments, the terminal device may process the content information in the first information based on the first image, may process the layout information in the first information based on the first image, or may process the content information in the first information and the layout information in the first information based on the first image, which is not limited in the embodiment of the present disclosure.

Exemplarily, the first template includes sticker 1 and text 2, and the terminal device may replace sticker 1 and text 2 in the content information based on the first image, or the terminal device may move the position of sticker 1 and the position of text 2 in the layout information based on the first image.

In some embodiments, the second information may be used to generate a second template. For example, since the second information is determined based on the first information, the second information may be used to generate a second template, and the second template is generated based on the first template (for example, the sticker position of the first template is moved, the text content of the first template is modified, etc.).

In some embodiments, the terminal device may obtain the second information based on the following feasible implementation:
determining third information based on the first image and processing at least one of the content information and the layout information based on the third information to obtain the second information.

In this way, the terminal device can adjust the first information based on the information of the first image to obtain the second information, so that the degree of matching between the second information and the first image can be improved, and the accuracy of the second information can be improved.

The third information may be for indicating information of the first image.

In some embodiments, the third information may include at least one of the following:
a first text for describing content of the first image;
a tag for indicating the content of the first image; and
a heat map for indicating the saliency of respective areas in the first image.

In this way, the terminal device may process the content information in the first information and the layout information in the first information based on various information of the first image, thereby improving the accuracy of information processing.

The first text may be used to describe the content of the first image. For example, if the first image includes a big tree and a little cat, and the little cat is sitting on a branch of the big tree, the first text may be "the little cat is sitting on the tree". For example, if the first image includes a piece of blue sky and a little bird is flying in the sky, the first text may be "the little bird is flying in the blue sky". For example, if the first image includes a small stream, there is a big stone beside the small stream, and a fishing man is sitting on the big stone, the first text may be "a man is sitting on a stone beside a stream to fish".

Optionally, the electronic device may identify the content of the first image based on any feasible implementation, determining the first text for describing content of the first image based on the first image includes: identifying content of the first image to obtain an identified content, and generating a corresponding text description as the first text based on the identified content. The type of the electronic device is not limited in the embodiments of the present disclosure.

The tag may be for indicating the content of the first image. For example, the tag may indicate scene information, content information, etc. of the first image. For example, if the first image includes a big tree and a little cat, and the little cat is sitting on a branch of the big tree, the tag may include "big tree" and "little cat". For example, if the first image includes a piece of blue sky and a little bird is flying in the sky, the tag may include "little bird" and "blue sky". For example, if the first image includes a small stream, there is a big stone beside the small stream, and a fishing man is sitting on the big stone, the tag may include "man", "small stream" and "stone".

Optionally, the terminal device may identify the content of the first image based on any feasible implementation, and the terminal device may select tags matching the content of the first image in a tag library (for example, select tags based on similarity degree of the text), thereby obtaining the tag for indicating the content of the first image.

The heat map may be for indicating the saliency of each area in the first image. For example, the saliency may be a characteristic that an area with the saliency in the first image is more likely to attract visual attention than other areas. For example, the heat map may display the distribution and density of data in space in a graphical manner, and therefore, the heat map of the first image may indicate the position of an object in the first image, the area with the saliency is the area where the object in the first image is located. For example, the first image includes a big tree and a little cat, in the heat map of the first image, the area where the big tree is located and the area where the little cat is located have higher heat, and other areas have lower heat. In this way, the electronic device may accurately determine the position of the big tree and the position of the little cat based on the heat map.

Optionally, the electronic device may perform saliency segmentation (saliency seg) on the first image and determine the heat map of the first image based on a segmentation result.

Optionally, the electronic device may perform human parsing (human parse) on the first image and determine the heat map of the first image based on a parsing result.

Optionally, the electronic device may perform face detection (face detect) on the first image and determine the heat map of the first image based on a face detection result.

Optionally, the electronic device may also perform saliency segmentation, human parsing and face detection processing on the first image and determine the heat map of the first image based on a processing result, so that the accuracy of the heat map may be improved.

In some embodiments, the electronic device may replace the content information based on the third information. For example, the electronic device may replace the stickers, text content, filters, etc. in the first template based on the first text and the tag. For example, the electronic device may determine, based on the first text and the tag, that the current stickers in the first template do not match with the first image, and in this way, the electronic device may select stickers matching with the first image in a sticker library based on the first text and the tag, and replace the stickers in the first template with the stickers matching with the first image. For example, the electronic device may determine a new piece of text matching with the first image based on the first text and replace the text in the content image with the new piece of text.

In some embodiments, the electronic device may adjust the layout information based on the third information. For example, the electronic device may adjust the position of a sticker and the position of a text box in the first template based on the heat map. For example, the first image includes a face, and the electronic device may determine, based on the heat map of the first image and the layout information of the first template, that the sticker in the first template will cover the face in the first image, and in this way, the electronic device may adjust the position of the sticker in the layout information so that the sticker will not cover the face in the first image.

Exemplarily, the content information in the first information may include sticker 1, filter 2 and text 3, and the layout information in the first information may include position A of sticker 1 and position B of text 3. The electronic device determines text 4 based on the first text corresponding to the first image, and determines sticker 5 based on the first text and the tag that are corresponding to the first image. The electronic device adjusts position A to position C based on the heat map corresponding to the first image, and in this way, the electronic device can obtain the second information. The content information in the second information may include sticker 5, filter 2 and text 4, and the layout information in the second information includes position C and position B, position C is the position of sticker 5 and position B is the position of text 4.

S203: generating a second template based on the second information.

In some embodiments, the electronic device may generate the second template in a preset format based on the second information. For example, the electronic device may process the second information based on a non-linear editing (Non-Linear Editing, NLE) method to obtain the second template, so that the second template is convenient for the user to browse, thereby improving the user experience.

It should be noted that the electronic device may process the second information to obtain the second template based on any feasible implementation, which is not limited in the embodiments of the present disclosure.

S204: processing the first image based on the second template to obtain a second image.

Optionally, the electronic device may edit the first image based on the second template to obtain the second image. For example, in the embodiment shown in FIG. 1, the electronic device may import the first image into the second template to obtain the second image. The second image may include sticker 1 and text 3 in the second template, and the position of sticker 1 in the second image is the same as the position of sticker 1 in the second template, and the position of text 3 in the second image is the same as the position of text 3 in the second template.

An embodiment of the present disclosure provides an image processing method, in the image processing method, an electronic device may acquire a first image and first information of a first template used for the first image, and determine third information based on the first image; the electronic device may process at least one of content information in the first information and layout information in the first information based on the third information to obtain second information, and the electronic device may generate a second template based on the second information and process the first image based on the second template to obtain a second image. In the above method, since the third information may include a first text, a tag and a heat map associated with the first image, the electronic device can accurately adjust the content information and the layout information, thereby improving the accuracy of the second information and the degree of matching between the content information and the layout information of the second template and the first image. Moreover, in this way, the main content of the first image can be prevented from being covered by the content information in the second template, and therefore, a user does not need to edit the second image multiple times, thereby reducing the complexity of image editing and improving the efficiency of image editing.

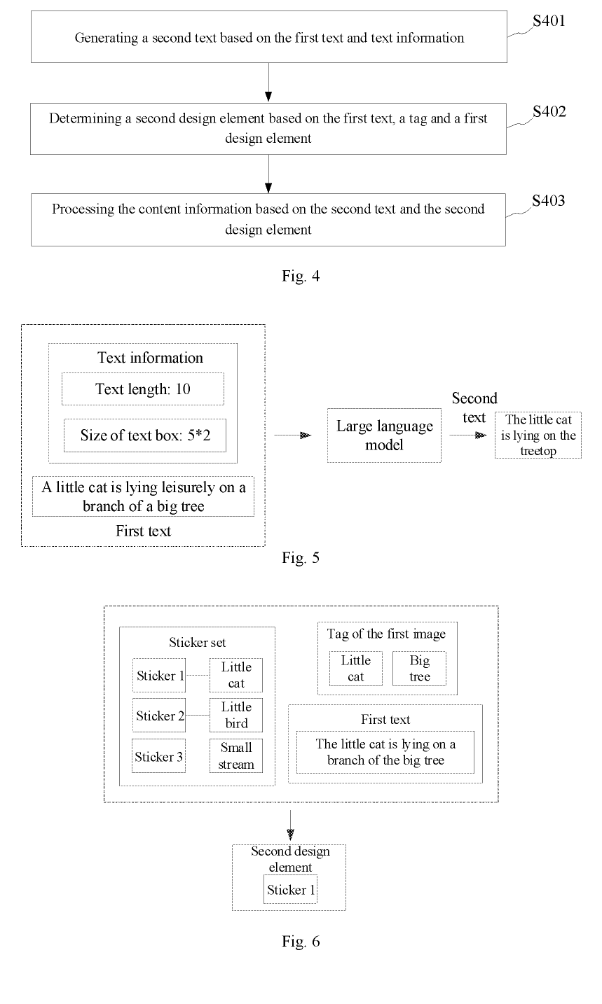

Based on the embodiment shown in FIG. 2, a method of processing the content information by the electronic device based on the third information in the above image processing method will be described in detail below with reference to FIG. 4.

FIG. 4 is a schematic diagram of a method for processing content information provided by an embodiment of the present disclosure. In the embodiment shown in FIG. 4, the content information may include text information and a first design element. Referring to FIG. 4, the method flow includes the following steps.

S401: generating a second text based on the first text and the text information.

In some embodiments, the text information may include any information associated with a text. For example, the text information may include information such as text content, text length, and size of a text box in the second template, which is not limited in the embodiment of the present disclosure.

In some embodiments, the second text may be a copywriting when the second image is published. For example, the second text may be displayed in the second image. For example, the first text is "a little cat is lying leisurely on a branch of a big tree", and the electronic device may modify the first text to obtain the second text "the little cat is lying on the treetop".

The electronic device generates the second text based on the first text and the text information, which may specifically include: determining a text length and a size of a text box based on the text information and generating the second text based on the first text, the text length and the size of the text box. In this way, the second text matches with the text format in the first template, thereby improving the accuracy and display effect of the second text.

In some embodiments, when the first template is produced, the text in the first template may be designed as a placeholder, which does not have any practical meaning, and therefore, in the second template, this text may be replaced with the second text matching the first image.

In some embodiments, the electronic device may process the first text, the text length and the size of the text box based on a language model, the text length and the size of the text box are constraints for generating the second text, so that the format of the obtained second text changes little. For example, the electronic device may generate the second text suitable for social media publication based on a large language model and the first text, and the second text may include a title, a subtitle, a long text, graphic symbols, etc. The length of the second text is similar to the text length corresponding to the text information, and the electronic device may segment and wrap the second text based on the size of the text box, so that the format of the second text is adapted to the text box. For example, if the text length is 6 characters and the size of the text box is 4*2 characters, the electronic device identifies the content of the first text based on the large language model and generates the second text based on an identification result, and the length of the second text may also be 6 characters, and the first three characters are on one line and the last three characters are on another line.

Next, a process of generating the second text by the terminal device will be described with reference to FIG. 5.

FIG. 5 is a schematic diagram of a process of generating a second text provided by an embodiment of the present disclosure. Referring to FIG. 5, FIG. 5 includes a first text "a little cat is lying leisurely on a branch of a big tree", text information and a large language model. The text information includes a text length and a size of a text box, the text length is 10, and the size of the text box is 5*2. An electronic device (not shown in FIG. 5) may input the first text, the text length and the size of the text box into the large language model, and the large language model may output a second text "the little cat is lying on the~treetop~", and "the little cat is lying on" is on the first line of the text box, and "the~treetop~" is on the second line of the text box. In this way, the content of the second text is associated with the first image, and the format of the second text is similar to the format of the text in the first template, so that the accuracy of the second text may be improved.

S402: determining a second design element based on the first text, the tag and a first design element.

In some embodiments, the first design element may include design elements such as a filter, a sticker, a font, a font color, a background, and a text box in the first template, which is not limited in the embodiments of the present disclosure.

In some embodiments, the second design element may be associated with the first text and the tag, and a type of the first design element may be the same as a type of the second design element. For example, if the first design element is a filter, the second design element may be a filter associated with the first text and the tag, and if the first design element is a sticker, the second design element may be a sticker associated with the first text and the tag.

In some embodiments, after determining the type of the second design element, the electronic device may select the second design element from multiple preset design elements based on the first text and the tag. For example, if the type of the second design element is a sticker, the electronic device may select a sticker associated with the first text and the tag in a sticker library to obtain the second design element, and if the type of the second design element is a filter, the electronic device may select a filter associated with the first text and the tag in a filter library to obtain the second design element.

Exemplarily, the sticker library may include multiple stickers, and each sticker has a corresponding tag or text description. The electronic device may determine the text similarity between, the tag or text description corresponding to each sticker, and the first text and the tag of the first image, and determine the sticker with the greatest text similarity as the second design element, or determine the sticker with the text similarity greater than or equal to a first threshold as the second design element.

Exemplarily, the filter library may include multiple filters, and each filter has a corresponding tag or text description. The electronic device may determine the text similarity between, the tag or text description corresponding to each filter, and the first text and the tag of the first image, and determine the filter with the greatest text similarity as the second design element, or determine the filter with the text similarity greater than or equal to a second threshold as the second design element.

Next, a process of determining the second design element will be described with reference to FIG. 6.

FIG. 6 is a schematic diagram of a process of determining a second design element provided by an embodiment of the present disclosure. Referring to FIG. 6, FIG. 6 includes a sticker set, a tag of the first image and a first text. The sticker set may include sticker 1, sticker 2, sticker 3, etc., the tag of sticker 1 is a little cat, the tag of sticker 2 is a little bird, and the tag of sticker 3 is a small stream. The tag of the first image includes a little cat and a big tree. The first text is that the little cat is lying on a branch of the big tree. An electronic device (not shown in FIG. 6) may calculate the text similarity between the tag of sticker 1 and the tag of the first image as well as the first text, calculate the text similarity between the tag of sticker 2 and the tag of the first image as well as the first text, and calculate the text similarity between the tag of sticker 3 and the tag of the first image as well as the first text. Since the tag of sticker 1 has the highest similarity with the tag of the first image as well as the first text, the electronic device may determine that the second design element is sticker 1.

S403: processing the content information based on the second text and the second design element.

In some embodiments, the electronic device may process the content information based on the following feasible implementation: replacing the text in the text information with the second text, and replacing the first design element with the second design element in response to the correlation degree between the second design element and the first image being greater than the correlation degree between the first design element and the first image. In this way, the content information in the second information has a high degree of matching with the first image, and therefore, the second image generated by the electronic device has a high accuracy, thereby preventing the user from editing and adjusting the second image multiple times and improving the efficiency of image editing.

Exemplarily, if the text in the text information is text 1 and the second text is text 2, the electronic device may replace text 1 in the text information with text 2.

In some embodiments, the correlation degree between the second design element and the first image may be the text similarity between, a tag of the second design element or a text description of the second design element, and the first text and the tag of the first image; the correlation degree between the first design element and the first image may also be the text similarity between, a tag of the first design element or a text description of the first design element, and the first text and the tag of the first image. For example, the second design element may be a sticker, if the value of the text similarity between the tag of this sticker and the first text and the tag of the first image is 1, the value of the correlation degree between this sticker and the first image may also be 1, and if the value of the text similarity between the text description of this sticker and the first text and the tag of the first image is 2, the value of the correlation degree between the sticker and the first image may also be 2.

In some embodiments, in response to the correlation degree between the second design element and the first image being greater than the correlation degree between the first design element and the first image, it indicates that the second design element matches with the first image better, and therefore, the electronic device may replace the first design element in the content information with the second design element. In response to the correlation degree between the second design element and the first image being less than or equal to the correlation degree between the first design element and the first image, it indicates that the first design element matches with the first image better, and therefore, the electronic device may not replace the first design element in the content information with the second design element.

Exemplarily, the text in the content information is "today's weather is good", the sticker is a sticker of cloud, the content of the first image is a little cat lying on a branch of a big tree, and the tag of the first image is a little cat and a big tree. The electronic device may determine that the second text is "the little cat is lying on the treetop" and determine that the second design element is a sticker of the little cat. In this way, the electronic device may replace the text in the content information with "the little cat is lying on the treetop", and since the sticker of the little cat matches the first image better, the electronic device may replace the sticker of cloud in the content information with the sticker of the little cat.

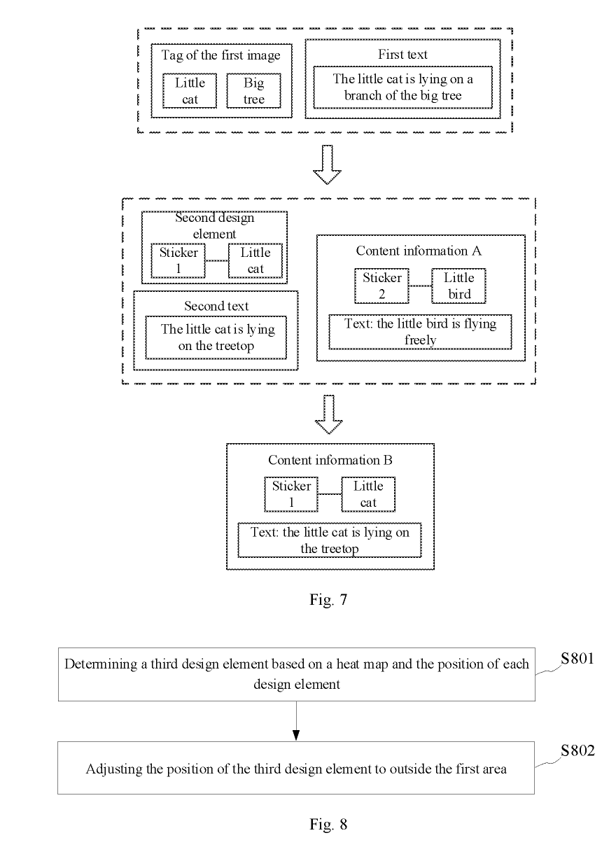

Next, a process of processing the content information by the electronic device will be described with reference to FIG. 7.

FIG. 7 is a schematic diagram of processing content information provided by an embodiment of the present disclosure. Referring to FIG. 7, it includes a tag of a first image, a first text and content information A. The tag of the first image includes a little cat and a big tree, and the first text is that the little cat is lying on a branch of the big tree. The content information A includes sticker 2 and a text, the tag of sticker 2 is a little bird, and the content of the text is: the little bird is flying freely.

Referring to FIG. 7, an electronic device (not shown in FIG. 7) may determine a second design element and a second text based on the tag of the first image and the first text, the second design element is sticker 1, the tag of sticker 1 is a little cat, and the second text is “the little cat is lying on the treetop”. Since the correlation degree between sticker 1 and the first image is greater than the correlation degree between sticker 2 and the first image, the electronic device may process sticker 2 and the text in the content information A to obtain content information B. The content information B includes sticker 1 (tagged as a little cat) and the text: the little cat is lying on the treetop. In this way, the electronic device can accurately process the content information, thereby improving the accuracy of the processed content information.

An embodiment of the present disclosure provides a method for processing content information. An electronic device may determine a text length and a size of a text box based on text information and generate a second text based on a first text, the text length and the size of the text box. The electronic device may determine a second design element based on the first text, a tag and a first design element, replace a text in the text information with the second text, and replace the first design element with the second design element in response to the correlation degree between the second design element and a first image being greater than the correlation degree between the first design element and the first image. In the above method, the second text is similar in format to the text in the first template, and since the second design element has a high correlation with the first image, the accuracy of the processed content information is high, thereby improving the accuracy of the second template and the accuracy of the second image, and preventing the user from editing and adjusting the second image multiple times, thereby improving the efficiency of image editing.

Based on any one of the above embodiments, a method of processing the layout information by the electronic device based on the third information in the above image processing method will be described in detail below with reference to FIG. 8.

FIG. 8 is a schematic diagram of a method for processing layout information provided by an embodiment of the present disclosure. In the embodiment shown in FIG. 8, the layout information may include the position of each design element in the first template, and the method flow includes:

S801: determining a third design element based on a heat map and the position of each design element.

In some embodiments, the position of the design element may refer to the position of the design element in the first template.

The position of the third design element coincides with a first area in the heat map, and the saliency of the first area is greater than or equal to a preset threshold. For example, the saliency of the first area being greater than or equal to the preset threshold may mean that the heat value of the first area is greater than or equal to a preset heat value, that is, the main content of the first image may exist in the first area. For example, the first image may include a big tree and a little cat, in the heat map of the first image, the heat value of the area where the big tree is located is greater than the preset heat value, and the heat value of the area where the little cat is located is also greater than the preset heat value, and therefore, the electronic device may determine that the first area includes the area where the big tree is located and the area where the little cat is located.

Exemplarily, the first image may include a face, and the heat map of the first image may include area 1, area 2 and area 3, the heat value of area 1 is greater than the preset heat value, and the heat values of area 2 and area 3 are less than the preset heat value, and in this way, the electronic device may determine that the first area is area 1, that is, the face exists in the first area of the first image.

Exemplarily, the first image may include a face, the heat map of the first image may include area 1, area 2 and area 3, design element A is in area 1, design element B is in area 2, and design element C is in area 3. If the heat value of area 1 is greater than the preset heat value, the electronic device may determine that the face is in area 1 and determine design element A as the third design element. If the heat value of area 2 is greater than the preset heat value, the electronic device may determine that the face is in area 2 and determine design element B as the third design element. If the heat values of area 2 and area 3 are greater than the preset heat value, the electronic device may determine that the face is in area 2 and area 3 and determine design element B and design element C as the third design elements.

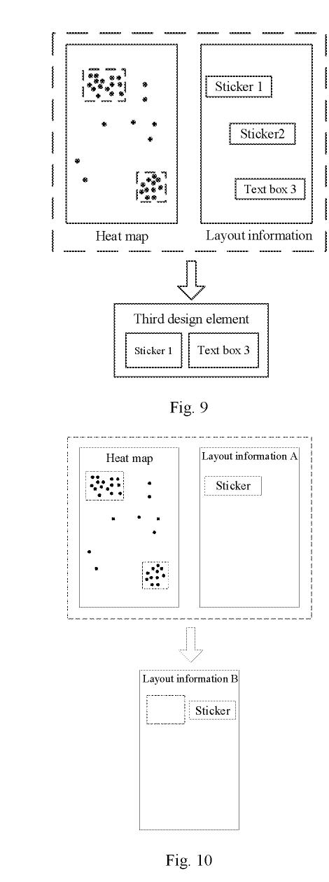

Next, a process of determining the third design element will be described with reference to FIG. 9.

FIG. 9 is a schematic diagram of a process of determining a third design element provided by an embodiment of the present disclosure. Referring to FIG. 9, FIG. 9 includes a heat map and layout information. The heat map may include multiple heat values, and an electronic device (not shown in FIG. 9) may determine that the heat map includes two first areas (areas with dotted line boxes). The layout information includes the position of sticker 1 in the first template, the position of sticker 2 in the first template and the position of text box 3 in the first template.

Referring to FIG. 9, the electronic device may determine, based on the heat map and the layout information, that sticker 1 coincides with the first one of the first areas, text box 3 coincides with the second one of the first areas, and sticker 2 does not coincide with the first area, and therefore, the electronic device may determine that the third design elements include sticker 1 and text box 3. In this way, the electronic device can accurately determine the third design element that may cover the content of the first image based on the heat map and the layout information, thereby improving the accuracy of determining the third design element.

S802: adjusting the position of the third design element to outside the first area.

In some embodiments, after determining the third design element, the electronic device may adjust the third design element to outside the first area where the third design element is located.

In some embodiments, the electronic device may adjust the position of the third design element to a second area, and the saliency of the second area is less than the preset threshold. For example, the saliency of the second area being less than the preset threshold may mean that the heat value of the second area is less than the preset heat value, that is, the main content of the first image may not exist in the second area. For example, the first image may include a big tree, a little cat, blue sky and grassland. In the heat map of the first image, the heat values of the area where the big tree is located and the area where the little cat is located are greater than the preset heat value, and the heat values of the area where the blue sky is located and the area where the grassland is located are less than the preset heat value, that is, the first area includes the area where the big tree is located and the area where the little cat is located, and the second area includes the area where the blue sky is located and the area where the grassland is located.

In some embodiments, the electronic device may adjust the third design element to a second area adjacent to the first area. For example, the third design element coincides with the first area of the heat map, and the second area of the heat map includes area 1 and area 2. If area 1 is adjacent to the first area, the electronic device may adjust the third design element to area 1, and if area 2 is adjacent to the first area, the electronic device may adjust the third design element to area 2.

Exemplarily, the first image may include a face, the heat map of the first image may include area 1, area 2 and area 3, area 1 is the first area, and a sticker is in area 1, and the electronic device determines that the sticker will cover the face in the first image. If area 2 is adjacent to area 1, the electronic device may adjust the sticker to area 2, and if area 3 is adjacent to area 1, the electronic device may adjust the sticker to area 3.

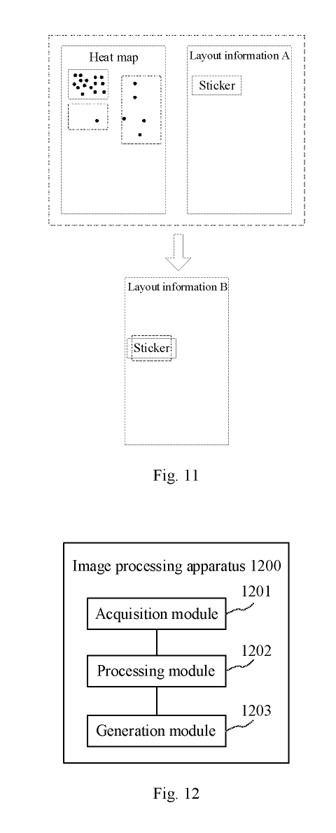

Next, a process of adjusting the position of the third design element to outside the first area by the electronic device will be described with reference to FIG. 10 and FIG. 11.

FIG. 10 is a schematic diagram of adjusting the position of a third design element provided by an embodiment of the present disclosure. Referring to FIG. 10, FIG. 10 includes a heat map and layout information A. The heat map may include multiple heat values, and an electronic device (not shown in FIG. 10) may determine that the heat map includes two first areas (areas with dotted line boxes). The layout information A includes the position of a sticker in the first template. The electronic device may determine, based on the heat map and the layout information A, that the sticker coincides with the first of the first areas, and therefore, the electronic device may determine that the sticker is the third design element and move the position of the sticker out of the first area to obtain layout information B.

FIG. 11 is another schematic diagram of adjusting the position of a third design element provided by an embodiment of the present disclosure. Referring to FIG. 11, FIG. 11 includes a heat map and layout information A. The heat map may include multiple heat values, and an electronic device (not shown in FIG. 11) may determine that the heat map includes one first area (an area with a solid line box) and two second areas (areas with dotted line boxes). The layout information A includes the position of a sticker in the first template. The electronic device may determine, based on the heat map and the layout information A, that the sticker coincides with the first area, and therefore, the electronic device may determine that the sticker is the third design element. Since the second area below the first area is closer to the first area, the electronic device may move the position of the sticker to the second area below the first area to obtain layout information B.

In some embodiments, after the electronic device processes the layout information, the above method further includes: determining the position of the text box of the second text based on the processed layout information, determining the main hue of the area where the text box is located based on the position of the text box, and determining the font color of the second text based on the main hue.

In some embodiments, the electronic device may further determine the font color in the design element. Since the second text may be displayed in the text box, the electronic device may determine the main hue of the area where the text box is located and determine the font color of the second text, so that the situation that the display effect of the second text is poor due to the mismatch between the font color of the second text and the main hue of the area where the text box is located can be avoided, thereby improving the display effect of the second image.

Exemplarily, if the main hue of the area where the text box is located is light green, the electronic device may determine that the font color of the second text cannot be light cyan, light yellow and other colors that are easily confused with light green, and the electronic device may determine that the font color of the second text is dark blue, dark gray and other colors that are easily distinguishable from light green.

It should be noted that the electronic device may determine the font color of the second text based on the main hue based on any feasible implementation, which is not limited in the embodiment of the present disclosure.

An embodiment of the present disclosure provides a method for processing layout information, in the method, an electronic device may determine, based on a heat map and the position of each design element, a third design element that coincides with a first area in the heat map and adjust the third design element to outside the first area where the third design element is located, moreover, the electronic device may further determine the position of a text box of a second text based on the processed layout information, determine the main hue of the area where the text box is located based on the position of the text box, and determine the font color of the second text based on the main hue. In the above method, since the electronic device may adjust the position of the design element that covers the main content of the first image, the situation that the design element covers the content of the first image may be avoided, and since the font color of the second text matches the main hue of the area where the text box is located, the display effect of the second text may be improved, thereby improving the display effect of the second image.

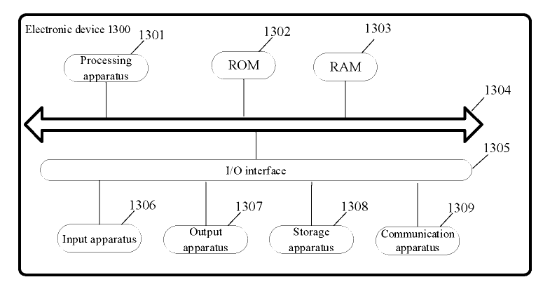

FIG. 12 is a schematic diagram of a structure of an image processing apparatus provided by an embodiment of the present disclosure. Referring to FIG. 12, the image processing apparatus 1200 includes an acquisition module 1201, a processing module 1202 and a generation module 1203.

The acquisition module 1201 is configured to acquire a first image and first information of a first template used for the first image, the first information including content information of the first template and layout information of the first template;

the processing module 1202 is configured to process at least one of the content information in the first information and the layout information in the first information based on the first image to obtain second information;

the generation module 1203 is configured to generate a second template based on the second information; and

the processing module 1202 is further configured to process the first image based on the second template to obtain a second image.

In this way, the electronic device can adjust the content and layout of the first template based on the first image, so that the accuracy of the generated second template may be improved, and the degree of matching between the second template and the first image may be improved. Moreover, a user does not need to edit the second image obtained based on the second template multiple times, thereby reducing the complexity of image editing and improving the efficiency of image editing.

According to one or more embodiments of the present disclosure, the processing module 1202 is further configured to:
determine third information based on the first image, the third information being for indicating information of the first image; and
process at least one of the content information and the layout information based on the third information to obtain the second information.

In this way, the terminal device can adjust the first information based on the information of the first image to obtain the second information, so that the degree of matching between the second information and the first image can be improved, and the accuracy of the second information can be improved.

According to one or more embodiments of the present disclosure, the third information includes at least one of the following:
a first text for describing the content of the first image;
a tag for indicating the content of the first image; and
a heat map for indicating the saliency of each area in the first image.

In this way, the terminal device can process the content information and layout information of the first information based on various information of the first image, thereby improving the accuracy of information processing.

According to one or more embodiments of the present disclosure, the processing module 1202 is further configured to:
generate a second text based on the first text and text information in the content information;
determine a second design element based on the first text, the tag and a first design element in the content information, the second design element being associated with the first text and the tag, and a type of the first design element being the same as a type of the second design element; and
process the content information based on the second text and the second design element.

In this way, the second text is similar in format to the text in the first template, and since the second design element has a high correlation with the first image, the accuracy of the processed content information is high, thereby improving the accuracy of the second template and the accuracy of the second image, and preventing the user from editing and adjusting the second image multiple times, thereby improving the efficiency of image editing.

According to one or more embodiments of the present disclosure, the processing module 1202 is further configured to:
determine a text length and a size of a text box based on the text information; and
generate the second text based on the first text, the text length and the size of the text box.

In this way, the second text matches the text format in the first template, thereby improving the accuracy and display effect of the second text.

According to one or more embodiments of the present disclosure, the processing module 1202 is further configured to:
replace a text in the text information with the second text; and
replace the first design element with the second design element in response to the correlation degree between the second design element and the first image being greater than the correlation degree between the first design element and the first image.

In this way, the content information in the second information has a high degree of matching with the first image, and therefore, the second image generated by the electronic device has high accuracy, thereby preventing the user from editing and adjusting the second image multiple times and improving the efficiency of image editing.

According to one or more embodiments of the present disclosure, the processing module 1202 is further configured to:
determine a third design element based on the heat map and the position of each of the design elements, a position of the third design element coinciding with a first area in the heat map, and the saliency of the first area being greater than or equal to a preset threshold; and
adjust the position of the third design element to outside the first area to obtain a processed layout information.

In this way, since the electronic device may adjust the position of the design element that covers the main content of the first image, the situation that the design element covers the content of the first image can be avoided.

According to one or more embodiments of the present disclosure, the processing module 1202 is further configured to:
determine the position of the text box of the second text based on the processed layout information;
determine the main hue of the area where the text box is located based on the position of the text box; and
determine the font color of the second text based on the main hue.

In this way, the situation that the display effect of the second text is poor due to the mismatch between the font color of the second text and the main hue of the area where the text box is located can be avoided, thereby improving the display effect of the second image.

The image processing apparatus provided by the embodiment of the present disclosure may be used to implement the technical solutions of the above method embodiments, and the implementation principles and technical effects thereof are similar, and details are not repeated here in the embodiment.

FIG. 13 is a schematic diagram of a structure of an electronic device provided by an embodiment of the present disclosure. Referring to FIG. 13, it shows a schematic diagram of a structure of an electronic device 1300 suitable for implementing the embodiments of the present disclosure. The electronic device may include, but is not limited to, mobile terminals such as mobile phones, notebook computers, digital broadcast receivers, personal digital assistants (abbreviated as PDA), tablet computers, portable media players (abbreviated as PMP), vehicle terminals (such as car navigation terminal), and fixed terminals such as digital TV and desktop computers. The electronic device shown in FIG. 13 is only an example, and should not impose any limitation on the function and scope of use of the embodiments of the present disclosure.

As shown in FIG. 13, the electronic device 1300 may include a processing apparatus (such as a central processing unit, a graphics processor and the like) 1301, which may perform various appropriate actions and processes based on a program stored in a read-only memory (abbreviated as ROM) 1302 or a program loaded into a random access memory (abbreviated as RAM) 1303 from a storage apparatus 1308. In the RAM 1303, various programs and data required for the operation of the electronic device 1300 are also stored. The processing apparatus 1301, the ROM 1302 and the RAM 1303 are connected to each other through a bus 1304. An input/output (I/O) interface 1305 is also connected to the bus 1304.

Usually, the following apparatus may be connected to the I/O interface 1305: an input apparatus 1306 including, for example, a touch screen, a touchpad, a keyboard, a mouse, a camera, a microphone, an accelerometer, a gyroscope and the like; an output apparatus 1307 including, for example, a liquid crystal display (Liquid Crystal Display, LCD for short), a speaker, a vibrator and the like; a storage apparatus 1308 including, for example, a magnetic tape, a hard disk and the like; and a communication apparatus 1309. The communication apparatus 1309 may allow the electronic device 1300 to perform wireless or wired communication with other devices to exchange data. Although FIG. 13 shows an electronic device 1300 with various apparatuses, it should be understood that not all the apparatuses shown here need to be implemented or provided. More or fewer apparatuses may be implemented or provided alternatively.

In particular, according to the embodiments of the present disclosure, the process described above with reference to the flowchart may be implemented as a computer software program. For example, an embodiment of the present disclosure includes a computer program product, which includes a computer program carried on a computer-readable medium, where the computer program contains program code for performing the method shown in the flowchart. In such an embodiment, the computer program may be downloaded and installed from a network through the communication apparatus 1309, or installed from the storage apparatus 1308, or installed from the ROM 1302. When the computer program is executed by the processing apparatus 1301, the above-mentioned functions defined in the method of the embodiment of the present disclosure are executed.

It should be noted that the above-mentioned computer-readable medium in the present disclosure may be a computer-readable signal medium, a computer-readable storage medium, or any combination of the two. The computer-readable storage medium may be, for example, but is not limited to, an electrical, magnetic, optical, electromagnetic, infrared, or semiconductor system, apparatus or device, or any combination of the above. More specific examples of the computer-readable storage medium may include, but are not limited to: an electrical connection with one or more conductors, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus or device. In the present disclosure, the computer-readable signal medium may include a data signal propagated on a baseband or as a part of a carrier wave, and computer-readable program code is carried in the data signal. This propagated data signal may take many forms, including but not limited to an electromagnetic signal, an optical signal, or any suitable combination of the above. The computer-readable signal medium may also be any computer-readable medium other than the computer-readable storage medium, and the computer-readable signal medium may send, propagate or transmit the program used by or in combination with the instruction execution system, apparatus or device. The program code contained on the computer-readable medium may be transmitted by any suitable medium, including but not limited to: wire, optical cable, RF (radio frequency), etc., or any suitable combination of the above.

The above-mentioned computer-readable medium may be included in the above-mentioned electronic device, or may exist alone without being assembled into the electronic device.

The above-mentioned computer-readable medium carries one or more programs, and when the above-mentioned one or more programs are executed by the electronic device, the electronic device is caused to execute the method shown in the above-mentioned embodiments.

An embodiment of the present disclosure provides a computer-readable storage medium, on which computer-executable instructions are stored, and the computer-executable instructions , when executed by a processor, implement various possible methods involved in the above embodiments.

An embodiment of the present disclosure provides a computer program product, including a computer program, and the computer program, when executed by a processor, implements various possible methods involved in the above embodiments.

The computer program code for performing the operations of the present disclosure may be written in one or more programming languages or a combination thereof. The above-mentioned programming languages include object-oriented programming languages such as Java, Smalltalk, C++, and also conventional procedural programming languages such as "C" language or similar programming languages. The program code may be executed entirely on a user's computer, partly on the user's computer, as a stand-alone software package, partly on the user's computer and partly on a remote computer, or entirely on the remote computer or server. In the case of involving the remote computer, the remote computer may be connected to the user's computer through any kind of network, including a local area network (abbreviated as LAN) or a wide area network (abbreviated as WAN), or it may be connected to an external computer (for example, connected by using Internet provided by an Internet service provider).

The flowcharts and block diagrams in the drawings illustrate the possibly implemented architectures, functions and operations of the system, method and computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the block may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units involved in the embodiments of the present disclosure may be implemented by software or by hardware. The name of a unit does not constitute a limitation on the unit itself under certain circumstances, for example, the first acquiring unit may also be described as "a unit for acquiring at least two internet protocol addresses".

The functions described above herein may be performed at least partially by one or more hardware logic components. For example, without limitation, exemplary types of hardware logic components that may be used include: field programmable gate array (FPGA), application specific integrated circuit (ASIC), application specific standard product (ASSP), system on chip (SOC), complex programmable logical device (CPLD) and the like.

According to the electronic device, the computer-readable storage medium and the computer program product provided by the embodiments of the present disclosure, the electronic device may adjust the content and layout of the first template based on the first image, so the accuracy of the generated second template may be improved. Moreover, since the degree of matching between the second template and the first image is high, the user does not need to edit the second image obtained based on the second template multiple times, thereby reducing the complexity of image editing and improving the efficiency of image editing.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include: an electrical connection based on one or more conductors, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

It should be noted that the modifiers of "one" and "multiple" mentioned in the present disclosure are illustrative rather than restrictive, and those skilled in the art should understand that they should be understood as "one or more" unless clearly indicated in the context otherwise.

The names of messages or information exchanged between multiple apparatuses in the implementations of the present disclosure are only used for illustrative purposes, and are not used to limit the scope of these messages or information.

It may be understood that the data involved in the technical solutions (including but not limited to the data itself, acquisition or use of the data) shall comply with requirements of corresponding laws, regulations and related provisions. The data may include information, parameters, messages and the like, such as the stream switching indication information.

The above description is only the preferred embodiments of the present disclosure and an explanation of the technical principles employed. Those skilled in the art should understand that the disclosed scope involved in the present disclosure is not limited to the technical solutions formed by the specific combination of the above technical features, but also covers other technical solutions formed by any combination of the above technical features or their equivalent features without departing from the above disclosed concept. For example, a technical solution formed by replacing the above features with technical features with similar functions disclosed in the present disclosure (but not limited thereto).

In addition, although the various operations are depicted in a particular order, this should not be understood as requiring these operations to be performed in the particular order shown or in a sequential order. Under certain circumstances, multitasking and parallel processing may be beneficial. Similarly, although the above discussion contains a number of specific implementation details, these should not be interpreted as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination. Although the subject matter has been described in language specific to the structural features and/or logical actions of the method, it should be understood that the subject matter defined in the appended claims is not necessarily limited to the specific features or actions described above. Conversely, the specific features and actions described above are only exemplary forms for implementing the claims.

1. An image processing method, comprising:
acquiring a first image and first information of a first template used for the first image, the first information comprising content information of the first template and layout information of the first template;
processing at least one of the content information in the first information and the layout information in the first information based on the first image to obtain second information; and
generating a second template based on the second information, and processing the first image based on the second template to obtain a second image.

2. The method according to claim 1, wherein processing at least one of the content information in the first information and the layout information in the first information based on the first image to obtain second information comprises:
determining third information based on the first image, the third information being for indicating information of the first image; and
processing the at least one of the content information and the layout information based on the third information to obtain the second information.

3. The method according to claim 2, wherein the third information comprises at least one of the following:
a first text for describing content of the first image;
a tag for indicating the content of the first image; and
a heat map for indicating saliency of each area in the first image.

4. The method according to claim 2, wherein the third information comprises a first text for describing content of the first image and a tag for indicating the content of the first image; the content information comprises text information and a first design element; and
processing the content information based on the third information comprises:
generating a second text based on the first text and the text information;
determining a second design element based on the first text, the tag and the first design element, the second design element being associated with the first text and the tag, and a type of the first design element being same as a type of the second design element; and
processing the content information based on the second text and the second design element.

5. The method according to claim 4, wherein the generating the second text based on the first text and the text information comprises:
determining a text length and a size of a text box based on the text information; and
generating the second text based on the first text, the text length and the size of the text box.

6. The method according to claim 4, wherein the processing the content information based on the second text and the second design element comprises:
replacing a text in the text information with the second text; and
replacing the first design element with the second design element in response to a correlation degree between the second design element and the first image being greater than a correlation degree between the first design element and the first image.

7. The method according to claim 4, wherein determining the first text for describing the content of the first image based on the first image comprises: identifying content of the first image to obtain an identified content, and generating a corresponding text description as the first text based on the identified content.

8. The method according to claim 2, wherein the third information comprises a heat map for indicating saliency of each area in the first image; the layout information comprises a position of each design element in the first template; and processing the layout information based on the third information comprises:
determining a third design element based on the heat map and the position of each of the design elements, a position of the third design element coinciding with a first area in the heat map, and the saliency of the first area being greater than or equal to a preset threshold; and
adjusting the position of the third design element to outside the first area to obtain a processed layout information.

9. The method according to claim 8, wherein after processing the layout information, the method further comprises:
determining a position of a text box of the second text based on the processed layout information;
determining a main hue of an area where the text box is located based on the position of the text box; and
determining a font color of the second text based on the main hue.

10. The method according to claim 8, wherein the saliency is a characteristic that an area with the saliency in the first image is more likely to attract visual attention than other areas.

11. The method according to claim 10, wherein the heat map of the first image indicates a position of an object in the first image, and the area with the saliency is the area where an object in the first image is located.

12. The method according to claim 1, wherein the first template includes a sticker and text content;
generating the second template based on the second information comprises:
moving a position of the sticker of the first template or modifying the text content of the first template.

13. The method according to claim 3, wherein the third information comprises a first text for describing content of the first image and a tag for indicating the content of the first image; the content information comprises text information and a first design element; and
processing the content information based on the third information comprises:
generating a second text based on the first text and the text information;
determining a second design element based on the first text, the tag and the first design element, the second design element being associated with the first text and the tag, and a type of the first design element being same as a type of the second design element; and
processing the content information based on the second text and the second design element.

14. The method according to claim 3, wherein the third information comprises a heat map for indicating saliency of each area in the first image; the layout information comprises a position of each design element in the first template; and
processing the layout information based on the third information comprises:
determining a third design element based on the heat map and the position of each of the design elements, a position of the third design element coinciding with a first area in the heat map, and the saliency of the first area being greater than or equal to a preset threshold; and
adjusting the position of the third design element to outside the first area to obtain a processed layout information.

15. An electric device, comprising: a processor and a memory, wherein
the memory stores computer-executable instructions; and
the processor executes the computer-executable instructions stored in the memory to cause the processor to execute an image processing method;
the image processing method comprises:
acquiring a first image and first information of a first template used for the first image, the first information comprising content information of the first template and layout information of the first template;
processing at least one of the content information in the first information and the layout information in the first information based on the first image to obtain second information; and
generating a second template based on the second information, and processing the first image based on the second template to obtain a second image.

16. The electric device according to claim 15, wherein processing at least one of the content information in the first information and the layout information in the first information based on the first image to obtain second information comprises:
determining third information based on the first image, the third information being for indicating information of the first image; and
processing the at least one of the content information and the layout information based on the third information to obtain the second information.

17. The electric device according to claim 16, wherein the third information comprises at least one of the following:
a first text for describing content of the first image;
a tag for indicating the content of the first image; and
a heat map for indicating saliency of each area in the first image.

18. The electric device according to claim 16, wherein the third information comprises a first text for describing content of the first image and a tag for indicating the content of the first image; the content information comprises text information and a first design element; and
processing the content information based on the third information comprises:
generating a second text based on the first text and the text information;
determining a second design element based on the first text, the tag and the first design element, the second design element being associated with the first text and the tag, and a type of the first design element being same as a type of the second design element; and
processing the content information based on the second text and the second design element.

19. The electric device according to claim 18, wherein the generating the second text based on the first text and the text information comprises:
determining a text length and a size of a text box based on the text information; and
generating the second text based on the first text, the text length and the size of the text box.

20. A non-transitory computer-readable storage medium, on which computer-executable instructions are stored, wherein when the computer-executable instructions are executed by a processor, an image processing method are implemented;
the image processing method comprises:
acquiring a first image and first information of a first template used for the first image, the first information comprising content information of the first template and layout information of the first template;
processing at least one of the content information in the first information and the layout information in the first information based on the first image to obtain second information; and
generating a second template based on the second information, and processing the first image based on the second template to obtain a second image.
